(19) United States
(12) Patent Application Publication
(10) Pub. No.: US 2016/0190615 A1
(43) Pub. Date: Jun. 30, 2016

(54) Fuel Cell System, Motor Vehicle Containing a Fuel Cell System, and Method for Operating a Fuel Cell System

(71) Applicants: Bayerische Motoren Werke Aktiengesellschaft, Muenchen (DE); ACAL Energy Limited, Runcorn (GB)

(72) Inventors: Robert LONGMAN, Runcorn (GB); Andrew Martin CREETH, Runcorn (GB); Nicholas DE BRISSAC BAYNES, Runcorn (GB); Johannes SCHMID, Muenchen (DE); Stefan HAASE, Muenchen (DE); Stefan KREITMEIER, Reichertshofen (DE); Sylvester BURCKHARDT, Kirchseeon (DE)

(21) Appl. No.: 15/060,872

(22) Filed: Mar. 4, 2016

Related U.S. Application Data
(63) Continuation of application No. PCT/EP2014/068885, filed on Sep. 4, 2014.

(30) Foreign Application Priority Data
Sep. 6, 2013 (DE) 10 2013 217 858.1

(51) Int. Cl. H01M 8/04302; H01M 8/18; B60L 11/18; H01M 8/20; H01M 16/00; H01M 8/04223; H01M 8/2455

(52) U.S. Cl. CPC H01M 8/04302; H01M 8/04268; H01M 8/188; H01M 8/2455; H01M 8/20; H01M 16/003; B60L 11/1883; B60L 11/1885; H01M 2250/20

(57) ABSTRACT

A fuel cell system is provided having a plurality of fuel cells combined to form a fuel cell stack. The fuel cell system is characterized in that at least one fuel cell is a redox flow fuel cell having an electrode assembly, which electrode assembly has a proton-permeable separator, which separator is arranged between an anode region and a cathode region. The redox flow fuel cell has a regenerator spatially separated from the electrode assembly, and a water-forming reaction of the redox flow fuel cell occurs in the regenerator. The redox flow fuel cell also has at least one oxidation-fluid delivery unit for feeding oxidation fluid into the regenerator in order to perform the water-forming reaction in the regenerator of the redox flow fuel cell. The redox flow fuel cell also has a pumping circuit, comprising a pumping device and a pumping line, for transporting an electrochemical storage system through the cathode region or the anode region of the redox flow fuel cell and through the regenerator. The electrochemical storage system contains active redox molecules and is designed to receive and release electrons. The fuel cell system also has a control device, which is designed to adjust an available electrical and/or thermal power of the fuel cell system by changing a redox state of the electrochemical storage system.

### CROSS REFERENCE TO RELATED APPLICATIONS

This application is a continuation of PCT International Application No. PCT/EP2014/068885, filed Sep. 4, 2014, which claims priority under 35 U.S.C. §119 from German Patent Application No. 10 2013 217 858.1, filed Sep. 6, 2013, the entire disclosures of which are herein expressly incorporated by reference.

### BACKGROUND AND SUMMARY OF THE INVENTION

The present invention relates to a fuel cell system, to a motor vehicle containing a fuel cell system of said type, and to a method for operating a fuel cell system.

Fuel cell systems are known in a variety of embodiments. All fuel cell systems have in common the fact that they exhibit only limited dynamics, said limitation normally arising owing to restricted controllability of the oxidation fluid delivery unit contained in the fuel cell system. In the case of a fuel cell system being used in a motor vehicle, therefore, a high level of hybridization of fuel cell and high-voltage accumulator, and thus a high-voltage accumulator (battery) of high power, are necessary specifically in order to provide sufficient energy in an acceleration process (positive step change in load) or else in order to recuperate energy in the event of a negative step change in load. These are, however, susceptible to degradation. Batteries with high power capability are furthermore characterized by a high weight and a large structural volume, which is a disadvantage in particular for use in lightweight constructions. Furthermore, power deficits nevertheless arise, in particular during the acceleration process of a motor vehicle, owing to slow start-up times and reaction times of the oxidation fluid delivery unit and associated poor fuel cell system dynamics.

Taking this prior art as a starting point, it is therefore an object of the present invention to provide a fuel cell system which exhibits good dynamics, which is very powerful and which is designed to store or release energy quickly when required. It is also an object of the invention to provide a motor vehicle operated using a fuel cell system, which motor vehicle is characterized by good driving dynamics and very good driving comfort. It is a further object of the present invention to provide a method for operating a fuel cell system, which method makes it possible for the fuel cell system to be controlled easily and with a high level of variability and thus with dynamic power adaptation.

In the case of a fuel cell system, the object is achieved according to the invention in that the fuel cell system includes a plurality of fuel cells combined to form a fuel cell stack, wherein
at least one fuel cell is a redox flow fuel cell with an electrode arrangement, comprising a proton-permeable separator, for example an electrolyte membrane, which is arranged between an anode region and a cathode region, wherein
the redox flow fuel cell has a regenerator, which is spatially separate from the electrode arrangement, and a water-forming reaction of the redox flow fuel cell takes place in the regenerator, wherein
the redox flow fuel cell furthermore comprises at least one oxidation fluid delivery unit for feeding oxidation fluid into the regenerator in order for the water-forming reaction in the regenerator of the redox flow fuel cell to be performed, wherein
the redox flow fuel cell furthermore comprises a pump circuit with a pump apparatus and with a pump line, for the transport of an electrochemical storage system through the cathode region or the anode region of the redox flow fuel cell and through the regenerator, and the electrochemical storage system comprises active redox molecules and is designed to receive and release electrons.

As a further constituent of the invention, the fuel cell system includes a control device which is designed to adapt an available electrical and/or thermal power of the fuel cell system by changing a redox state of the electrochemical storage system.

The redox flow fuel cell differs from “normal” fuel cells in that the water-forming reaction, that is to say the formation of water from protons, electrons and oxygen, is spatially relocated, and thus takes place not in the cathode region, which is adjacent to the separator and which is situated opposite the anode region, but in a so-called regenerator which is spatially separate from said cathode region but which is connected to the other components of the fuel cell system by way of a corresponding transport system. Via a transport circuit, the regenerator is supplied with the protons which have been produced in the anode region and which have passed through the proton-permeable separator into the cathode region, and with the electrons which have been produced and which commonly flow via an external consumer. The circuit for the transport of the protons may be identical to the pump circuit for conducting the electrochemical storage system through the cathode region of the redox flow fuel cell, though may also constitute a separate circuit. The oxidation fluid required for the water-forming reaction, that is to say generally an oxidant, for example air or an oxidation gas such as oxygen, or a corresponding liquid (referred to herein by the expression “oxidation fluid”), is supplied to the regenerator via at least one oxidation fluid delivery unit, for example a compressor.

Within the meaning of the invention, an electrochemical storage system includes chemical, redox-active molecules or active redox molecules, which may be present both in reduced form and in oxidized form, wherein both forms form a redox pair, and wherein the electrochemical storage system can receive and release one and/or multiple electrons per redox-active molecule. The electrochemical storage system is preferably provided in the form of a solution of the redox-active molecules, and serves for the storage and the transport of electrons.

It is preferably the case that the active redox molecule itself, or a solvent contained in the electrochemical storage system, transports protons. Furthermore, it is preferably the case that the electrochemical storage system exhibits low electrical conductivity. It is also preferably the case that the electrochemical storage system itself does not discharge, or discharges only very slowly.

The fuel cell system according to the invention may include one or more control devices. Here, a control device is designed such that it can initiate a change of the redox state of the electrochemical storage system and thus adapt the electrical and/or thermal power of the fuel cell system. The information regarding the electrical state of the electrochemical storage system and further parameters, such as liquid level, temperatures, pressures, pH value, conductivity etc., are provided to the control unit by way of sensors and/or model calculations.

If electrical power is to be drawn from the fuel cell system (positive load situation), the electrochemical storage system is changed from the oxidized state to the reduced state. This is performed by promoting the anode reaction of the redox flow fuel cell. The electrons thus released are received by the electrochemical storage system in the cathode region after passing through a load. In other words, a ratio of the reduced form of the electrochemical storage system and of the oxidized form of the electrochemical storage system is adapted in favor of the reduced form. If, for example, the ratio of the reduced form and of the oxidized form tends toward infinity, then from this point in time, only as many electrons can be received as can be released again in the regenerator. This corresponds to a maximum continuous power of the fuel cell system.

In the recuperation situation (negative load situation), it is possible for electrical power either to be supplied to the oxidation fluid delivery unit for the activation and/or operation thereof, and/or, if the fuel cell system has a high-voltage accumulator, to charge the high-voltage accumulator. Here, a ratio of the reduced form of the electrochemical storage system and of the oxidized form of the electrochemical storage system is adapted in favor of the oxidized form.

The control device is thus designed such that, by changing the redox state of the electrochemical storage system, said control device controls the anode reaction (release of electrons) independently of the water-forming reaction (consumption of electrons) and thus adapts the redox state of the electrochemical storage system to the power demands on the fuel cell system. This is possible by virtue of the electrochemical storage system serving as a so-called “buffer” for electrons. Furthermore, the control unit can regulate the concentration of the redox-active molecules or active redox molecules, the solvent content (for example water) and a fill level of the electrochemical storage molecule in the pump circuit, for example by way of temperatures and/or an efficiency of an optionally provided solvent recovery installation (condenser).

Whereas it is the case in a conventional fuel cell that the water-forming cathode reaction necessitates the anode reaction (and vice versa), and thus the power of the fuel cell is restricted substantially by the rate of supply of combustion fluids and oxidation fluids to the respective reaction region, it is possible in the case of the redox flow fuel cell for the anode reaction to be decoupled from the cathode reaction, and for the electrochemical storage system to be adjusted into the intended redox state, by virtue of electrons being received and stored by the electrochemical storage system. In the event of a positive load situation, that is when power is drawn by an external consumer or a load, it is now possible, in addition to the “normal” fuel cell reaction with the conventional production of water through the combination of the cathode reaction and anode reaction, and thus production of energy, for electrons to be received or temporarily stored by the electrochemical storage system, until said electrons are discharged by way of the water-forming reaction in the presence of relatively low loads. Here, the electrochemical storage system changes from the oxidized state into the reduced state. The power of the redox flow fuel cell is thus temporarily increased in relation to a conventional fuel cell.

Owing to the characteristic of the control device of changing the redox state of the electrochemical storage system and adapting the power demands to the fuel cell system, a fuel cell system with dynamic power adaptation is thus obtained, which can deal with very high power demands even within a short period of time. It is thus also possible for energy to be drawn significantly more quickly upon the start-up of the fuel cell system.

In one advantageous refinement of the fuel cell system, the control device is designed to adapt the electrical power of the fuel cell system by way of a change of the redox state of at least 10% of the redox-active molecules (or active redox molecules) of the electrochemical storage system. This improves the dynamic power adaptation of the fuel cell system.

Furthermore, the control device is advantageously designed to increase the electrical power of the fuel cell system beyond the maximum power predefined by the oxidation fluid delivery unit by initiating a reduction of the electrochemical storage system. A particularly high level of electrical power can be drawn in this way.

It is likewise advantageously the case that the control device is designed to provide the electrical power of the fuel cell system without activation of the oxidation fluid delivery unit by initiating a reduction of the electrochemical storage system. Specifically in the event of short positive step changes in load, a release of energy is possible without a time delay. Furthermore, in this way, the inert oxidation fluid delivery units are conserved.

A further advantageous refinement provides that the control device is designed to effect a regeneration of the electrochemical storage system by feeding in recuperation energy. This is realized, for example, by activation of the oxidation fluid delivery unit or by electrochemical charging of the electrochemical storage system.

The regeneration of the electrochemical storage system is advantageously performed by feeding recuperation energy into the oxidation fluid delivery unit.

It is furthermore advantageously the case that the control device is designed to regulate the pump in stepped and/or continuously variable fashion in a manner dependent on a substance amount of the active redox molecules of the electrochemical storage system. This permits operation adapted to the fuel cell and with the best possible efficiency. The substance amount of the active redox molecules of the electrochemical storage system is large if the concentration of the electrochemical storage system in a given constant volume is high.

It is furthermore advantageously the case that the control device is designed such that, if the substance amount of the active redox molecules of the electrochemical storage system is low, that is to say for example in the case of a volume of the electrochemical storage system of less than 8 L/100 kW fuel cell system power, in the event of a positive step change in load, the control device immediately activates the oxidation fluid delivery unit and provides electrical power by initiating a reduction of the electrochemical storage system. In this way, power deficits during the start-up of the oxidation fluid delivery unit are minimized, and faster response behavior of the fuel cell system is promoted.

If the substance amount of the electrochemical storage system is high, for example in the case of a volume of the electrochemical storage system of more than 8 L/100 kW fuel cell system power, the control device is advantageously designed such that in the event of a positive step change in load, the control device provides electrical power by initiating a reduction of the electrochemical storage system and activates the oxidation fluid delivery unit after a delay of several seconds, in particular of 0 to 20 seconds, preferably of 1 to 10 seconds, and particular preferably of 2 to 4 seconds. It is thus possible for a sufficiently high level of power to be drawn from the fuel cell system when required and, at the same time, for the inert oxidation fluid delivery unit to be conserved, wherein the energy-consuming oxidation fluid delivery unit can be activated at a later point in time and thus the full power of the fuel cell system (power of the fuel cell stack plus power from the electrochemical storage system of the redox flow fuel cell) is available immediately upon the starting of the fuel cell system. Alternatively or in addition, a device or a circuit for the smooth start-up of the oxidation fluid delivery unit may be provided (cf. FIG. 3). Such means for smooth start-up are those which eliminate or reduce the high start-up currents that are encountered in the case of a direct drive. These include, for example, frequency inverters or soft starters. It is thus possible for the start-up currents and ultimately the start-up power to be reduced. Furthermore, the maximum electrical power required for the operation of the oxidation fluid delivery unit can be reduced, and a corresponding motor for this purpose can be provided with lower power.

In an advantageous refinement, the control device is designed such that, in the event of a negative step change in load, the control device supplies recuperation energy that is obtained to the oxidation fluid delivery unit in order to activate or operate the latter. This saves energy upon the restarting of the oxidation fluid delivery unit in the event of a subsequent positive step change in load, without the dynamics of the fuel cell system being adversely impaired.

To improve the dynamic power adaptation of the fuel cell system, the fuel cell system according to the invention has at least one battery. The battery and the storage system preferably provide the required power. Since the electrochemical storage system is likewise suitable for storing energy, it is possible in this case for the battery to have a relatively low capacity or power. Furthermore, the battery is conserved by the buffer action of the electrochemical storage system specifically in the event of intense step changes in power, which lengthens the service life of the battery.

It is furthermore advantageous for the control device to be designed such that, in the event of a negative step change in load, the control device supplies the recuperation energy that is obtained to the oxidation fluid delivery unit and/or to the battery.

For faster provision of the power of the fuel cell system, the control device is preferably designed such that, during the start-up of the fuel cell system or during a cold start or frost start, the control device reduces a pump power of the pump apparatus in order to bring the fuel cell system to operating temperature.

The present invention also relates to motor vehicle which includes a fuel cell system as described above. The fuel cell system according to the invention is, owing to its good dynamics, particularly well-suited for use in a motor vehicle, and thus provides a high level of driving dynamics and a high level of driving comfort.

The refinements, advantages and effects described for the fuel cell system according to the invention also apply to the motor vehicle according to the invention.

The invention likewise also relates to a method for operating a fuel cell system having multiple fuel cells combined to form a fuel cell stack, wherein
at least one fuel cell is a redox flow fuel cell with an electrode arrangement, comprising a proton-permeable separator, in particular an electrolyte membrane, which is arranged between an anode region and a cathode region, wherein
the redox flow fuel cell has a regenerator, which is spatially separate from the electrode arrangement, and a water-forming reaction of the redox flow fuel cell takes place in the regenerator which is spatially separate from the electrode arrangement, wherein
the redox flow fuel cell furthermore comprises at least one oxidation fluid delivery unit for feeding oxidation fluid into the regenerator in order for the water-forming reaction in the regenerator of the redox flow fuel cell to be performed, wherein
the redox flow fuel cell furthermore comprises a pump circuit with a pump apparatus and with a pump line, for the transport of an electrochemical storage system through the cathode region or the anode region of the redox flow fuel cell and through the regenerator, and the electrochemical storage system comprises active redox molecules and is designed to receive and release electrons.

Here, the method according to the invention includes the step of adapting an available electrical and/or thermal power of the fuel cell system by changing a redox state of the electrochemical storage system. As discussed above, this step is initiated by way of a control device. For the reasons stated above, and incorporating the effects and advantages already described, it is possible by way of the method according to the invention for a fuel cell system to be controlled easily and with good power dynamics in accordance with the power demands on the fuel cell system.

The refinements, advantages and effects described for the fuel cell system according to the invention and the motor vehicle according to the invention also apply to the method according to the invention for operating a fuel cell system.

In an advantageous refinement of the method according to the invention, the method is characterized by the step of adapting the electrical power of the fuel cell system by way of a change of the redox state of at least 10% of the redox-active molecules of the electrochemical storage system. This improves the dynamics of the power provision of the fuel cell system.

To provide a particularly high level of power that goes beyond the “normal” power of a fuel cell system, the method provides for increasing the electrical power of the fuel cell system beyond the maximum power predefined by the oxidation fluid delivery unit by initiating a reduction of the electrochemical storage system.

By means of the step, provided in accordance with an advantageous refinement, of providing the electrical power of the fuel cell system without activation of the oxidation fluid delivery unit by initiating a reduction of the electrochemical storage system, it is possible, specifically in the case of short positive step changes in load, for energy to be released without a time delay. Furthermore, in this way, the inert oxidation fluid delivery units are conserved.

Furthermore, the method advantageously includes the step of regenerating the electrochemical storage system by feeding in recuperation energy. In this way, an at least partial, preferably complete, oxidation of the electrochemical storage system is realized, such that then, in a subsequent positive load situation, the full electrical power of the fuel cell system can be provided by initiating a reduction of the electrochemical storage system.

By way of regulating the pump apparatus in stepped and/or continuously variable fashion in a manner dependent on a substance amount of the active redox molecules of the electrochemical storage system, it is made possible for the required energy to be provided more precisely and more quickly.

The method according to the invention furthermore advantageously provides that, if the substance amount of the active redox molecules of the electrochemical storage system is low, in the event of a positive step change in load, the oxidation fluid delivery unit is immediately activated and power is provided by initiation of a reduction of the electrochemical storage system. In this way, power deficits during the start-up of the oxidation fluid delivery unit are minimized, and faster response behavior of the fuel cell system is promoted.

If the substance amount of the active redox molecules of the electrochemical storage system is high, the method according to the invention as per one refinement provides that, in the event of a positive step change in load, power is provided by initiation of a reduction of the electrochemical storage system and the oxidation fluid delivery unit is activated after a delay of several seconds, in particular of 0 to 20 seconds, preferably of 1 to 10 seconds and more preferably of 2 to 4 seconds. It is thus possible for a sufficiently high level of electrical power to be drawn from the fuel cell system when required and, at the same time, for the inert oxidation fluid delivery unit to be conserved. Alternatively or in addition, a device or a circuit for the smooth start-up of the oxidation fluid delivery unit may be provided (cf. FIG. 3). Such means for smooth start-up are those which eliminate or reduce the high start-up currents that are encountered in the case of a direct drive. These include, for example, frequency inverters or soft starters. It is thus possible for the start-up currents and ultimately the start-up power to be reduced. Furthermore, the maximum electrical power required for the operation of the oxidation fluid delivery unit can be reduced, and a corresponding motor for this purpose can be provided with lower power.

To save energy upon a restart of the oxidation fluid delivery unit in the event of a positive load situation following a negative load situation, without the dynamics of the fuel cell system being adversely impaired, it is provided according to one refinement of the method that, in the event of a negative step change in load, the recuperation energy that is obtained is supplied to the oxidation fluid delivery unit in order to activate or operate the latter.

To optimize the dynamic adaptation of the power of the fuel cell system, the fuel cell system has at least one battery, wherein here, the method is refined in that, in the event of a negative step change in load, the recuperation energy that is obtained is supplied to the oxidation fluid delivery unit and/or to the battery. In this way, the battery is conserved in the event of intense step changes in power, which lengthens the service life of the battery.

For faster provision of the power of the fuel cell system, the method is preferably refined in that, during the start-up of the fuel cell system or during a cold start or frost start, a pump power of the pump is reduced in order to bring the fuel cell system to operating temperature.

The solutions according to the invention and the refinements thereof yield the following advantages:
A highly dynamic, powerful and quickly responding fuel cell system is provided.
The fuel cell system can provide a level of power that is increased in relation to the “normal” power of a conventional fuel cell system.
Power deficits, in particular during start-up of the fuel cell system, are optimally bridged.
The control of the oxidation fluid demand is simplified by way of the options for readjustment of the oxidation fluid flow.
Disproportionate energy consumption as a result of starting-up of the oxidation fluid delivery unit, in particular in the event of high load demands, is prevented.
Recuperation energy can be used for the delivery of the oxidation fluid.
Through storage of recuperation energy in the electrochemical storage system, energy can be optimally saved and regenerated.
Any high-voltage accumulators that are provided, such as batteries, can be operated in a more conserving manner, and are characterized by a long service life.
The demands on capacity or power of a high-voltage accumulator are lower.
A motor vehicle with a high level of driving comfort and good power dynamics is provided.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a general schematic diagram of a redox flow fuel cell;

FIG. 2 is a schematic diagram of a control topology of a control device according to an embodiment of the invention;

FIG. 3 is a schematic illustration of the power curves of a fuel cell system as per a first advantageous refinement of the invention;

FIG. 4 is a schematic illustration of the power curves of a fuel cell system as per a second advantageous refinement of the invention;

FIG. 5 is a schematic illustration of the power curves of a fuel cell system as per a third advantageous refinement of the invention; and

FIG. 6 is a schematic illustration of current density-cell voltage curves for a cold start/frost start.

### DETAILED DESCRIPTION OF THE DRAWINGS

The figures illustrate only those aspects of the present invention that are of interest here; all other aspects have been omitted for the sake of clarity.

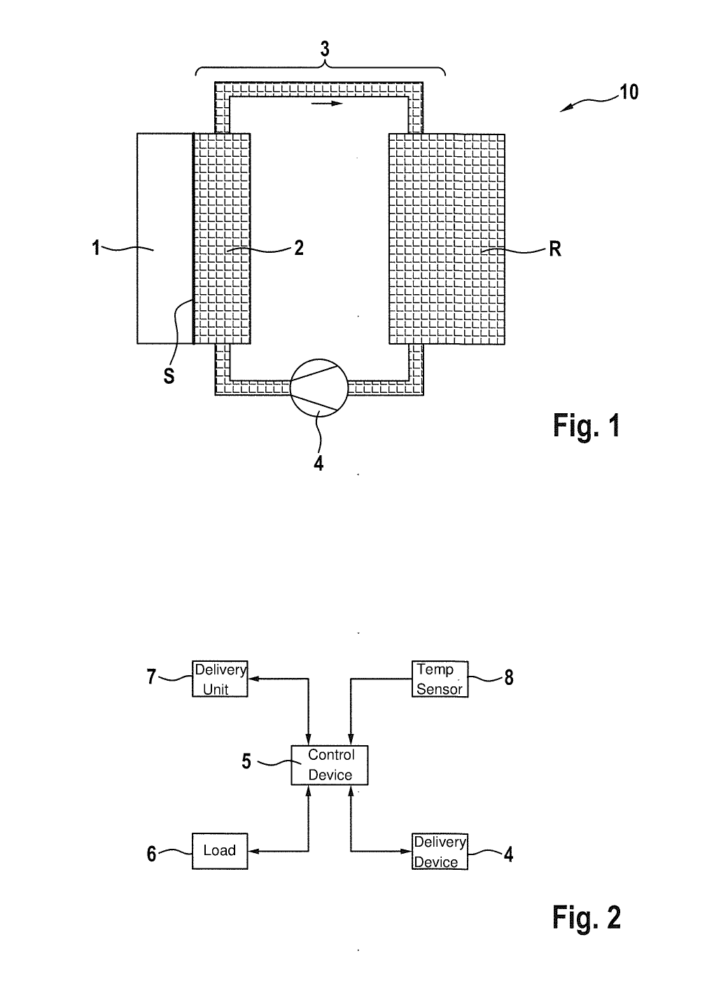

FIG. 1 shows a schematic view of a redox flow fuel cell 10 which includes an electrode arrangement with an anode region 1 and with a cathode region 2 which are separated from one another by a proton-permeable separator S. The redox flow fuel cell 10 furthermore includes a regenerator R which is spatially separate from the electrode arrangement and which is connected to the electrode arrangement by way of a pump circuit 3. The water-forming reaction of the redox flow fuel cell takes place in the regenerator R. For this purpose, an electrochemical storage system is transported via the pump circuit 3 and is circulated between the cathode region 2 and the regenerator R by way of a delivery device 4, for example, a pump. The electrochemical storage system stores and transports electrons, which electrons are received by the storage system after passing through a load in the cathode region 2, and the storage system conducts the electrons to the regenerator R, wherein the electrons react with protons and oxygen to form water.

In other words, as a result of the electrochemical reaction in the anode region 1, electrons are released which, after passing through a load, are received by the electrochemical storage system in the cathode region 2, which electrochemical storage system thus changes into a reduced state. The electrochemical storage system is then transported by the pump circuit 3 to the regenerator R. Here, if oxidation fluid and protons are also supplied to the regenerator R, the electrochemical storage system changes into the oxidized state, with a release of electrons. Based on the targeted control of the change of the redox state of the electrochemical storage system, it is possible according to the invention for the electrical power of a fuel cell system that contains the redox flow fuel cell 10 to be adapted.

FIG. 2 shows a schematic diagram of the control topology of the control device 5 according to the invention. Here, the control device 5 is provided for controlling an electrical load, that is to say an electrical consumer 6, an oxidation fluid delivery unit 7, and a delivery device for the electrochemical storage system 4, and for receiving data from a temperature sensor 8 for the electrochemical storage system. Optionally, the control device may also control a coolant pump and receive data from an oxidation state sensor, which gives information regarding the oxidation state of the electrochemical storage system.

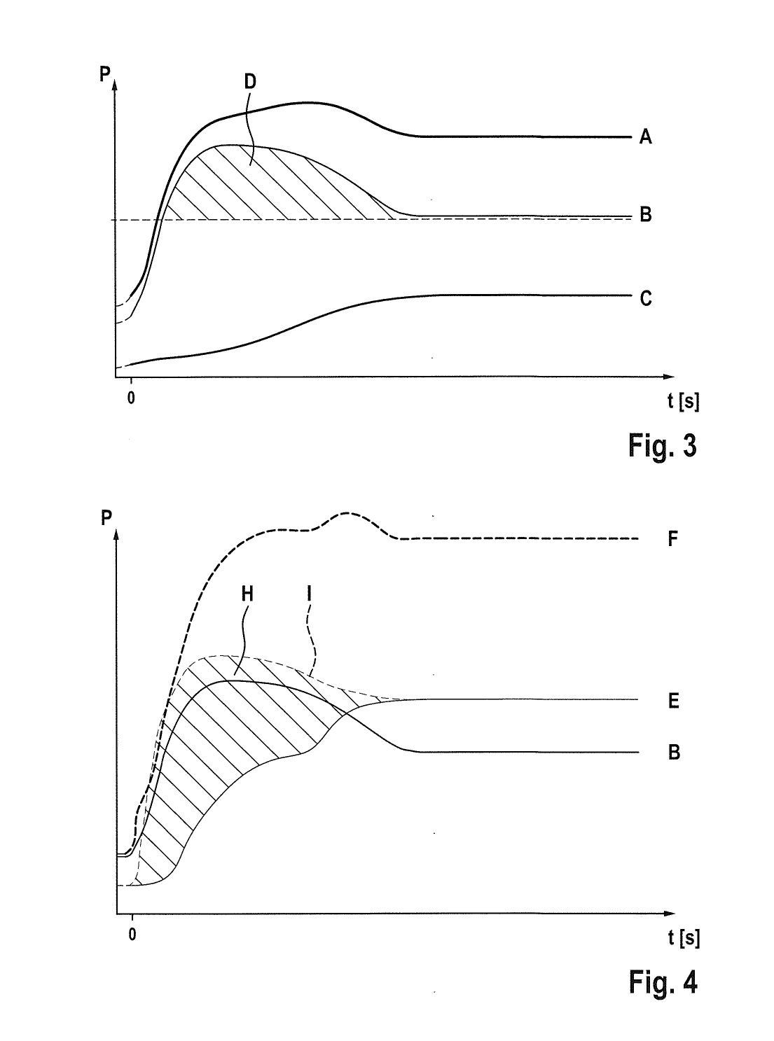

FIG. 3 shows a schematic illustration of the relevant power curves of a fuel cell system as per a first advantageous refinement of the invention. In detail, the power or the power demanded of the individual components of the fuel cell system is plotted versus the time in seconds.

Here, the fuel cell system has multiple fuel cells that have been stacked to form a fuel cell stack, wherein at least one fuel cell is a redox flow fuel cell. The fuel cell system need not include a high-voltage accumulator. Furthermore, the fuel cell system has a large substance amount of active redox molecules.

Owing to the large substance amount of active redox molecules of the electrochemical storage system, an oxidation fluid delivery unit can be activated with a time delay (for example 0 to 20 seconds, preferably 1 to 10 seconds and more preferably 2 to 4 seconds), such that, directly upon the start-up of the fuel cell system, no energy has to be expended for setting the oxidation fluid delivery unit in operation, which would lessen the overall power of the fuel cell system. The power absorbed by the oxidation fluid delivery unit and absent from the overall power of the system is illustrated in curve C. It can be clearly seen that, here, a smooth start-up of the oxidation fluid delivery unit is provided.

Curve A shows the electrical power of the overall fuel cell stack composed, for example, of “normal” fuel cells and redox flow fuel cells. After a minimum start-up time, which, in relation to a start-up time of a conventional fuel cell system comprising exclusively “normal” fuel cells, a constant power is delivered which originates from the electrode reactions. The very short start-up time is realized in that, during the start-up of the fuel cell system, electrochemical energy stored in the electrochemical storage system is additionally released. A relatively long time delay of the power rise of the fuel cell stack would otherwise be expected in this case too. For constancy of the power of the fuel cell stack, it is necessary, inter alia, for the oxidation fluid delivery unit to be activated in order that the regenerator is supplied with oxidation fluid. As an electrical consumer, the oxidation fluid delivery unit extracts power from the overall system (see curve C), which is evident in the fall in the power curve B of the fuel cell system after passing through a maximum. The resulting hatched region D is the energy available to a consumer, for example to a motor vehicle, owing to delayed activation of the oxidation fluid delivery unit.

FIG. 4 is a schematic illustration of the relevant power curves of a fuel cell system as per a second advantageous refinement of the invention.

By contrast to the fuel cell system from FIG. 3, the fuel cell system from FIG. 4 also includes a high-voltage accumulator, for example a battery.

Curve E shows the contribution made by the high-voltage accumulator to the power. It can be seen that the high-voltage accumulator, like conventional fuel cells, is not capable of providing power without a time delay upon the start-up of the fuel cell system. This is manifest in a slow rise of the curve E, the power curve of the high-voltage accumulator. The power deficit is in turn compensated by way of the electrochemical storage system, which yields an immediate rise of the overall power (curve F) composed of power of the fuel cell system (curve B) and power of the high-voltage accumulator (curve E) to a maximum. The maximum overall power (curve F) that is attained is greater than that from FIG. 3 owing to the cooperation of the high-voltage accumulator (curve E). The power curve of the fuel cell system (curve B) is analogous to that from FIG. 3, and shows a fall of the power curve of the fuel cell system (curve B) after passing through a maximum, which can be attributed to a time-delayed activation of an oxidation fluid delivery unit as an electrical consumer. FIG. 4 also includes curve I, which shows the power of a high-voltage accumulator as per a conventional fuel cell system. It can be seen that the power of the high-voltage accumulator must be run up to a very great extent in order to obtain the corresponding overall power (curve F). This is indicated by the hatched region H. The conventional control of a fuel cell system thus leads to degradation of the high-voltage accumulator.

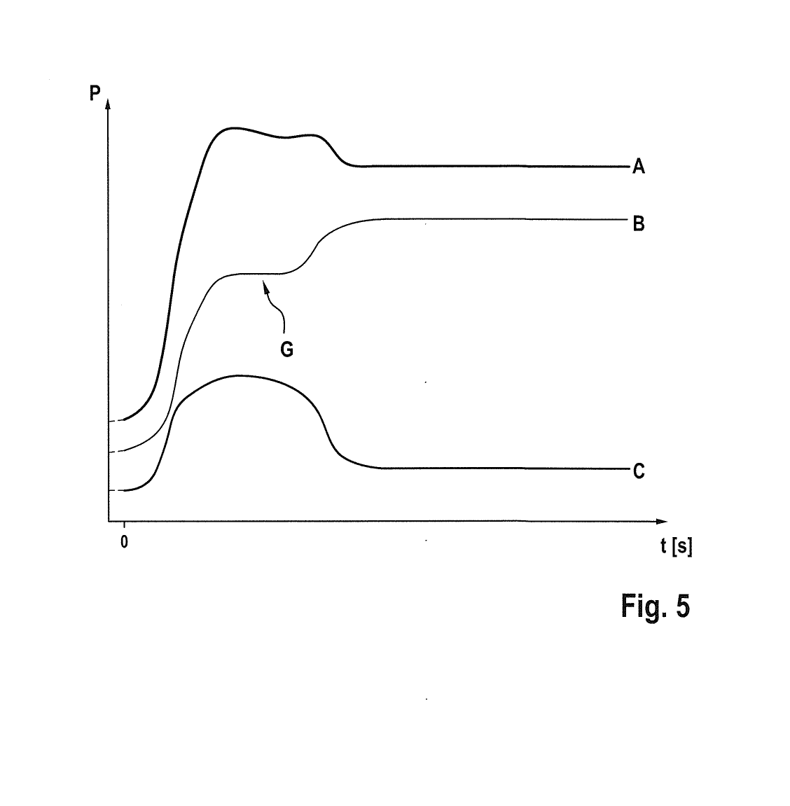

FIG. 5 is a schematic illustration of the relevant power curves of a fuel cell system as per a third advantageous refinement of the invention. In detail, it is again the case that the power of the individual components of the fuel cell system is plotted versus the time in seconds.

The fuel cell system includes, similarly to that from FIG. 3, multiple fuel cells that have been stacked to form a fuel cell stack, wherein at least one fuel cell is a redox flow fuel cell. The fuel cell system may include a high-voltage accumulator. Furthermore, by contrast to the fuel cell systems from FIGS. 3 and 4, the fuel cell system has a small substance amount of active redox molecules.

Owing to the small substance amount of active redox molecules of the electrochemical storage system, the oxidation fluid delivery unit is activated without a time delay, such that adequate power of the fuel cell system can be quickly provided immediately upon the start-up of the fuel cell system. A time delay of the initiation of the oxidation fluid delivery unit would be a disadvantage here because, owing to the small substance amount of active redox molecules, electrochemical power can be drawn from the electrochemical storage system only for a short period of time.

As in FIG. 3, the power of the fuel cell stack (curve A) rises immediately, which can be attributed to the power of the fuel cell stack, for example of the combination of “normal” fuel cells and redox flow fuel cells. Since it is however now the case that the oxidation fluid delivery unit is activated without a time delay, power is drawn more quickly after a short start-up time of the oxidation fluid delivery unit of the fuel cell system (curve B). This is manifest in a plateau G of the curve B. A greater amount of power is demanded for the start-up of the oxidation fluid delivery unit than for permanently maintaining the operation of the oxidation fluid delivery unit, as is evident from the fact that a maximum is passed through in the curve C. Consequently, the power of the fuel cell system (curve B) is reduced in relation to the power of the fuel cell stack (curve A). For example, in the case of a rated power of a fuel cell stack (curve A) of approximately 100 kW, it may be necessary, in the case of direct operation without use of means for smooth starting, such as inverters, soft starters etc., to use an oxidation fluid delivery unit with a rated power of approximately 25 kW and with a maximum start-up power of approximately 30 kW.

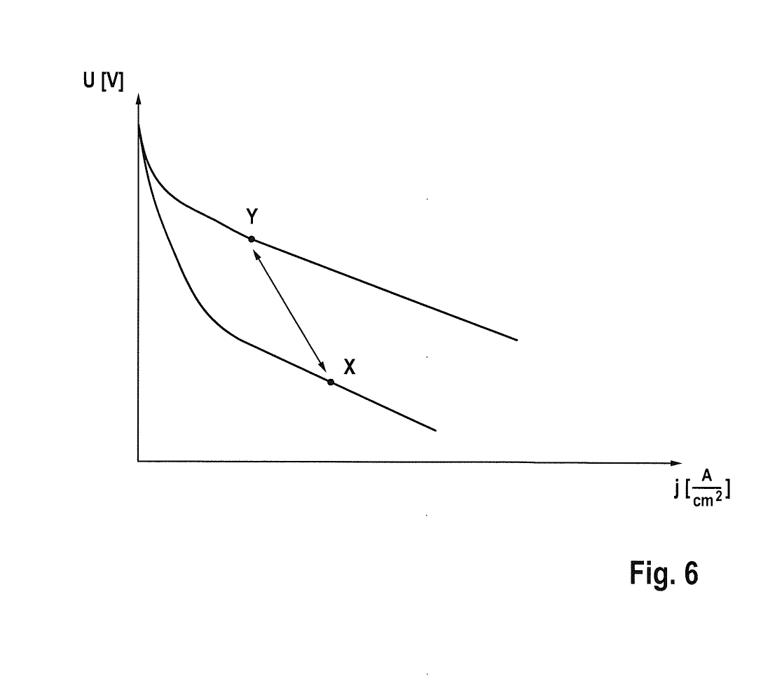

FIG. 6 is a schematic illustration of current density-cell voltage curves. The cell voltage U[V] is plotted versus the current density j in [A/cm²]. The lower curve shows a polarization curve in the case of low reagent concentration. The upper curve shows a polarization curve in the case of high reagent concentration. The plotted points X and Y are operating points with the same electrical power potential. In the event of a decrease in the reagent concentration, for the same current density, the activation overvoltage and concentration overvoltage of the reaction increase (in accordance with the Butler-Volmer equation). In this way, more heat and less electrical power are produced. This leads to lower electrical efficiency of the system. Furthermore, this effect is intensified in the presence of low temperatures.

### LIST OF REFERENCE DESIGNATIONS

1 Anode region
2 Cathode region
3 Pump circuit
4 Delivery device
5 Control apparatus
6 Electrical load
7 Oxidation fluid delivery unit
8 Temperature sensor for an electrochemical storage system
10 Redox flow fuel cell
R Regenerator
S Proton-permeable separator

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A fuel cell system, comprising:
a plurality of fuel cells combined to form a fuel cell stack, wherein
at least one fuel cell is a redox flow fuel cell with an electrode arrangement, comprising a proton-permeable separator which is arranged between an anode region and a cathode region,
the redox flow fuel cell has a regenerator, which is spatially separate from the electrode arrangement, and a water-forming reaction of the redox flow fuel cell takes place in the regenerator,
the redox flow fuel cell further comprises at least one oxidation fluid delivery unit for feeding oxidation fluid into the regenerator in order for the water-forming reaction in the regenerator of the redox flow fuel cell to be performed,
the redox flow fuel cell further comprises a pump circuit with a pump apparatus and with a pump line, for transport of an electrochemical storage system through the cathode region or the anode region of the redox flow fuel cell and through the regenerator, and the electrochemical storage system comprises active redox molecules and is designed to receive and release electrons, and
the fuel cell system further comprises a control device designed to adapt an available electrical and/or thermal power of the fuel cell system by changing a redox state of the electrochemical storage system.

2. The fuel cell system as claimed in claim 1, wherein the control device is designed to adapt the electrical power of the fuel cell system by way of a change of the redox state of at least 10% of the redox-active molecules of the electrochemical storage system.

3. The fuel cell system as claimed in claim 1, wherein the control device is designed to increase the electrical power of the fuel cell system beyond the maximum power predefined by the oxidation fluid delivery unit by initiating a reduction of the electrochemical storage system.

4. The fuel cell system as claimed in claim 1, wherein the control device is designed to provide the electrical power of the fuel cell system without activation of the oxidation fluid delivery unit by initiating a reduction of the electrochemical storage system.

5. The fuel cell system as claimed in claim 1, wherein the control device is designed to effect a regeneration of the electrochemical storage system by feeding in recuperation energy.

6. The fuel cell system as claimed in claim 5, wherein the regeneration of the electrochemical storage system is performed by feeding recuperation energy into the oxidation fluid delivery unit.

7. The fuel cell system as claimed in claim 1, wherein the control device is designed to regulate the pump apparatus in stepped and/or continuously variable fashion in a manner dependent on a substance amount of the active redox molecules of the electrochemical storage system.

8. The fuel cell system as claimed in claim 1, wherein the control device is designed such that:
if a substance amount of the active redox molecules of the electrochemical storage system is low, in an event of a positive step change in load, said control device immediately activates the oxidation fluid delivery unit and provides power by initiating a reduction of the electrochemical storage system, and/or
if the substance amount of the active redox molecules of the electrochemical storage system is high, in the event of a positive step change in load, said control device provides power by initiating a reduction of the electrochemical storage system and activates the oxidation fluid delivery unit after a delay of several seconds.

9. The fuel cell system as claimed in claim 1, wherein the control device is designed such that, in an event of a negative step change in load, said control device supplies recuperation energy that is obtained to the oxidation fluid delivery unit in order to activate the latter.

10. The fuel cell system as claimed in claim 1, further comprising a device and/or a circuit for smooth start-up of the oxidation fluid delivery unit.

11. The fuel cell system as claimed in claim 1, wherein the control device is designed such that, in the event of a negative step change in load, said control device supplies recuperation energy that is obtained to a battery in addition to or alternatively to the oxidation fluid delivery unit.

12. The fuel cell system as claimed in claim 1, wherein the control device is designed such that, during a start-up of the fuel cell system, said control device reduces a pump power of the pump apparatus in order to bring the fuel cell system to operating temperature.

13. A motor vehicle comprising a fuel cell system as claimed in claim 1.

14. A method for operating a fuel cell system having a plurality of fuel cells combined to form a fuel cell stack, wherein
at least one fuel cell is a redox flow fuel cel with an electrode arrangement, comprising a proton-permeable separator which is arranged between an anode region and a cathode region,
the redox flow fuel cell has a regenerator, which is spatially separate from the electrode arrangement, and a water-forming reaction of the redox flow fuel cell takes place in the regenerator,
the redox flow fuel cell further comprises at least one oxidation fluid delivery unit for feeding oxidation fluid into the regenerator in order for the water-forming reaction in the regenerator of the redox flow fuel cell to be performed, wherein
the redox flow fuel cell further comprises a pump circuit with a pump apparatus and with a pump line, for transport of an electrochemical storage system through the cathode region or the anode region of the redox flow fuel cell and through the regenerator, and the electrochemical storage system comprises active redox molecules and is designed to receive and release electrons,
the method comprises the step of adapting an available electrical and/or thermal power of the fuel cell system by changing a redox state of the electrochemical storage system.

15. The method as claimed in claim 14, wherein the step of adapting the electrical power of the fuel cell system is performed by way of a change of the redox state of at least 10% of the redox-active molecules of the electrochemical storage system.

16. The method as claimed in claim 14, further comprising the step of increasing the electrical power of the fuel cell system beyond a maximum power predefined by the oxidation fluid delivery unit by initiating a reduction of the electrochemical storage system.

17. The method as claimed in claim 14, further comprising the step of providing the electrical power of the fuel cell system without activation of the oxidation fluid delivery unit by initiating a reduction of the electrochemical storage system.

18. The method as claimed in claim 14, further comprising the step of regenerating the electrochemical storage system by feeding in recuperation energy.

19. The method as claimed in claim 18, wherein the step of regenerating the electrochemical storage system is performed by feeding recuperation energy into the oxidation fluid delivery unit.

20. The method as claimed in claim 14, further comprising the step of regulating the pump apparatus in stepped and/or continuously variable fashion in a manner dependent on a substance amount of the active redox molecules of the electrochemical storage system.

21. The method as claimed in claim 14, wherein:
if the substance amount of the active redox molecules of the electrochemical storage system is low, in an event of a positive step change in load, the oxidation fluid delivery unit is immediately activated and electrical power is provided by initiation of a reduction of the electrochemical storage system, and/or
if the substance amount of the active redox molecules of the electrochemical storage system is high, in the event of a positive step change in load, electrical power is provided by initiation of a reduction of the electrochemical storage system and the oxidation fluid delivery unit is activated after a delay of several seconds.

22. The method as claimed in claim 14, wherein, in the event of a negative step change in load, recuperation energy that is obtained is supplied to the oxidation fluid delivery unit in order to activate the unit.

23. The method as claimed in claim 14, wherein the system has a device and/or a circuit for smooth start-up of the oxidation fluid delivery unit.

24. The method as claimed in claim 14, wherein the fuel cell system comprises at least one battery and in that, in an event of a negative step change in load, recuperation energy that is obtained is supplied to the battery in addition or alternatively to the oxidation fluid delivery unit.

25. The method as claimed in claim 14, wherein, during a start-up of the fuel cell system, a pump power of the pump apparatus is reduced in order to bring the fuel cell system to operating temperature.
